(19) United States
(12) Patent Application Publication
(10) Pub. No.: US 2005/0067830 A1
(43) Pub. Date: Mar. 31, 2005

(54) Shielded label package and method of making the same

(75) Inventors: Edward Wilhelmus Mijdam, Buena Park, CA (US); Nick James Valestrino, Thousand Oaks, CA (US); Richard Cruz Florez, Glendale, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA (US)

(21) Appl. No.: 10/873,055

(22) Filed: Jun. 21, 2004

Related U.S. Application Data
(63) Continuation-in-part of application No. 10/085,688, filed on Feb. 26, 2002, now abandoned.

(51) Int. Cl. G09C 3/00

(52) U.S. Cl. 283/101

(57) ABSTRACT

A plurality of die cut labels formed on a label substrate attached on the surface of a carrier for the die cut label substrate. A protective cover, preferably but not necessarily formed of transparent material, is adhesively secured over the die cut label substrate by way of a dry peel adhesive deposited on the surface of the die cut label substrate. The dry peel adhesive is such that when the protective cover is removed from the die cut label substrate, no tacky adhesive residue remains on the protective cover or the label substrate.

### CROSS-REFERENCE TO RELATED APPLICATIONS

This application in a continuation in part and claims priority of U.S. patent application Ser. No. 10/085,688 filed Feb. 26, 2002 entitled “Shielded Label Package and Method of Making the Same” which is incorporated herein by reference for all purposes.

### FIELD OF THE INVENTION

The present invention relates generally to labels and more particularly to a package in which adhesive-backed labels may be marketed and which includes a removable protective shield which covers the labels and may be readily removed at the time of their use without leaving any tacky or sticky (glue like) adhesive residue.

### BACKGROUND OF THE INVENTION

Adhesive-backed labels are a common item found in many retail establishments at the present time. Such labels are typically mounted on a carrier or backing sheet which is coated with a release coating to enable the labels easy removal from the carrier for use. The adhesive-backed labels have many applications such as for personal organization, for communication, for product labeling, and may also be used for amusement purposes such as scrap booking, hobbies, crafts and school use.

Typically, in the marketing of such labels they are packaged in such a way as to be resistant to tampering by consumers and also to be readily available for display and stocking in modern retail sales environments. The two most typical current ways for packaging such labels for current retail sales are in boxes and in shrink-wrap packaging which includes a header card, or the products are logged. The costs incurred through utilization of either of these packaging techniques can approximate or even exceed the actual cost of the labels within the package themselves. In addition, both of these typical current ways for packaging have distinct disadvantages. When the labels are stored in boxes, they are not readily available for view by the Purchasing public and the retail clerks must remove the labels form the box on an item-by-item basis as they are called for by the customer. On the other hand, in shrink-wrapped packages which may be readily displayed on racks, easily viewed by the customers, the customer has a great deal of difficulty in removing the shrink-wrap packaging in order to be able to obtain access to the labels at the time of use.

U.S. Pat. No. 5,161,687 issued to Michael J. Kornell, et al., entitled “Reclosable Label Package.” describes a label package that is both resealable and reclosable. The package includes a set of labels formed with a label layer, which has a lateral portion surrounding the label layer. A top cover sheet is adhesively secured only in the lateral portions thereof so that it can be peeled back to allow access to the labels and then resealed to reclose the package. The adhesive material which is deposited at the lateral portion remains adhesively active when the transparent stock material covering the top face of the label layer is removed that that it can function by way of resealing the top cover layer after a label has been removed. In contrast to this, the instant invention provides a non-resealable, package that does not remain adhesively active when the transparent stock material covering the top face of the label layer is removed. The instant invention advantageously leaves no tacky residue on the cover of the labels.

Various other prior art systems have been suggested for covering adhesive-backed labels with a protective covering. Some examples of such prior art systems are shown in U.S. Pat. Nos. 2,671,678; 3,153,868; 3,854,229; 4,159,586; 4,204,706; 5,232,527; and 5,902,440.

The foregoing has outlined rather broadly, the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized that by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### SUMMARY OF THE INVENTION

A shielded label package including a plurality of die cut labels secured to a carrier and a protective cover secured to said carrier by an adhesive which when the protective cover is removed leaves no tacky adhesive residue on the carrier or the protective cover.

A method of making a shielded label package which includes the steps of providing a label substrate secured to a surface of a carrier, printing a plurality of labels on said label substrate, die cutting said plurality of labels, applying dry peel adhesive to said label substrate but displaced from said labels, securing a protective cover to said dry peel adhesive, and curing said dry peel adhesive.

### BRIEF DESCRIPTION OF THE DRAWINGS

For a more complete understanding of the present invention, reference is now made to the following descriptions taken in conjunction with the accompanying drawing, in which:

FIG. 1 is a top plan view of a shielded label package constructed in accordance with the principles of the present invention;

FIG. 2 is a cross-sectional view of the label package of FIG. 1 taken about the lines 2-2;

FIG. 3 is a cross-sectional view of an alternative label package structure; and

FIG. 4 is a schematic diagram of a system utilized to manufacture the shielded label package.

### DESCRIPTION OF THE PREFERRED EMBODIMENT

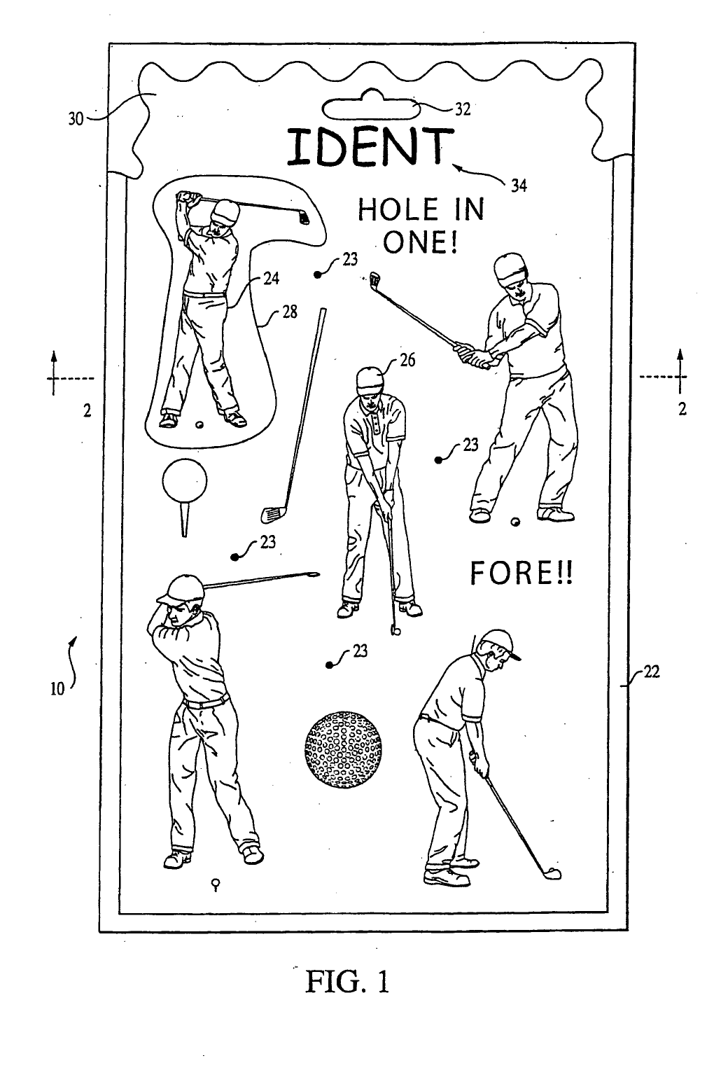

The shielded label package of the present invention is illustrated in FIG. 1 which shows a plurality of die cut labels which have been printed. The labels as represented in the drawing are abstract and should be recognized as capable of relating to any subject, for example, to resemble children's soccer and are designed to be peeled off and placed in scrapbooks, on lunch pales, notebooks, pencil carriers, clothing or other items generally used by parents, adults and children so as to identify the association of the child with the sport of soccer. Although obviously the theme of the die cut labels when used in this manner may vary depending upon the interest of the child or the parents and may be directed to other sports such as baseball, football, basketball, hockey or the like, or simply to general themes such as celebrations, birthdays, religious holidays or the like. Although the description of the present invention is given by illustration and description of die cut labels related to amusement or children's activities, it is to be understood by those skilled in the art that the present invention is equally applicable to the packaging of labels or cards with any dry peel which are used in personal organization, communication, correspondence, coding, product labeling, file folder identification and any other labels designed to be pealed off a carrier and used in the office, home or industrial environment. Thus, the use of the term “die cut labels” throughout the specification and claims is intended to include any type of label or card which may be die cut from a label substrate and which may or may not have adhesive layer thereon and which may or may not contain printing when the adhesive layer is included the label may subsequently be applied to an application substrate for any purpose desired without the adhesive layer the resulting label or card may be carried or presented for use for any purpose desired.

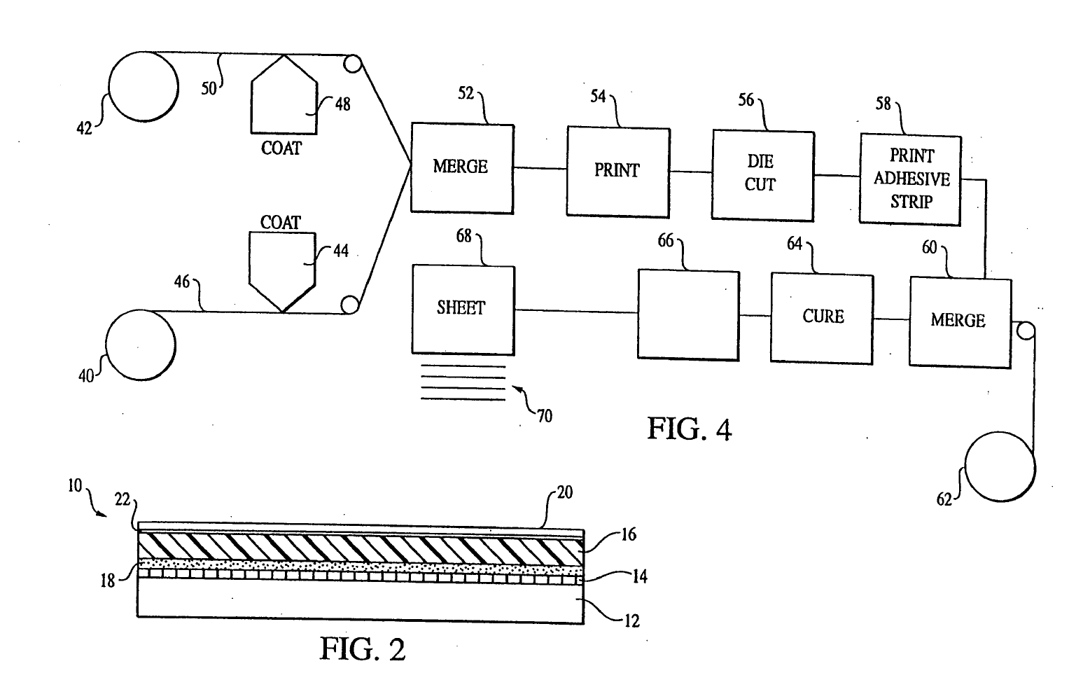

Referring now more particularly to FIGS. 1 and 2 there is schematically illustrated a shielded label package 10 constructed in accordance with the principles of the present invention. As is therein shown a carrier 12 (sometimes referred to as a base layer, liner, or backing sheet) has a release coating 14 applied to the upper surface thereof. The release coating 14 is an adhesive release agent of a type well known to the art, such as silicone coating. A label substrate 16 having a pressure-sensitive adhesive layer 18 applied to the bottom surface thereof is disposed over the release coating 14. The label substrate (sometimes referred to as a label layer) may be constructed from suitable stock material of various weights and styles. The labels may be highly glossy, semi-glossy, clear films, color films, metallized film, matte, paper or matte film and may be constructed of (without limitation) paperboard, polyester, vinyl foils, polyolefin, wood or other materials and may in fact contain multiple layers. The only criteria, which is universal, is that the material must be a material that could receive ink. It should, however, be understood that the resulting label may be blank such that the ultimate consumer may use it for any purpose desired including placing indicia thereon. The term “pressure-sensitive adhesive” as used herein is intended to include conventional tacky coatings typically used on paper products or the like to permit the user to secure one sheet of paper or film (a label) to a desired application substrate as desired by the consumer. Such adhesives are well known to those skilled in the art.

A protective cover 20 is secured to the top of the label substrate 16 by way of a strip of adhesive 22 which is disposed about the outer periphery of the label substrate 16. The protective cover 20 preferably is a transparent plastic film which can be secured to the label substrate by the adhesive 22 and which is of sufficient strength and weight to shield or cover the label substrate to protect it from handling, the elements and otherwise. If desired, the protective cover 20 may be translucent as opposed to transparent and may also have portions thereof which are opaque, for example, if areas appearing on the printed material on the label substrate are to be maintained in a manner such that the consumer cannot view them until the product is purchased and the protective cover removed. The protective cover may also be selected from a material having an outer surface which is capable of receiving ink which may be applied to identify the product. Alternatively and more preferably, the upper surface of the label substrate will contain such printed identification information as well as the printing forming the labels. It should be understood the printed indicia containing product information, security elements, pricing, stocking, trademarks or any other information may be printed anywhere on the upper surface of the label substrate depending upon the particular application.

As is illustrated in FIG. 1, various sketched characters such as shown at 24 and 26 are printed on the upper surface of the label substrate 16 and will provide the amusement or identification as may be desired for the particular application. The characters such as that shown at 24 is die cut as shown at 28 so that the character 24 may be removed from the label substrate and applied to any application substrate desired by the user. The pressure-sensitive adhesive 18 which remains on the lower surface (as viewed in FIG. 2) of the label substrate 16 permits the die cut figure (label) 24 to thus be applied. Die cutting is well known in the art and is such that a cut is formed around the FIG. 24 which passes completely through the label substrate 16 and through adhesive 18 so that the FIG. 24 along with the pressure-sensitive adhesive may be removed from the release coating 14 on the carrier 12.

Preferably the strip of adhesive 22 disposed about the periphery of the label substrate 16 is a dry peel adhesive which will secure the protective cover 20 to the label substrate 16. The term “dry peel adhesive” as used throughout the specification and claims means an adhesive which when the protective cover 20 is removed does not leave any tacky or sticky residue on the cover or the label substrate. Such an adhesive is preferably an ultraviolet cationic adhesive or other glue or adhesive that perform in a similar manner such as a coupon adhesive and one example is a water-based dry residue adhesive used to produce coupon labels, or any construction whereby two surfaces are separated where a non-tacky adhesive residue is left on either surface. One example of such adhesive is manufactured by Northwest Coatings Corp. of Oak Creek, Wis. and is sold as Item No. 20000C. After the protective cover 20 is secured to the label substrate 16, the layer of dry peel adhesive is cured by being subjected to ultraviolet radiation for a period of time sufficient to effect the curing. Alternatively, other curing or drying methods such as heat or air may be used as is well known to those skilled in the art. Thus, at least the outer periphery of the protective cover must be light permeable to allow the ultraviolet radiation to pass therethrough.

The protective cover 20 is secured around the outer periphery of the package 10 as shown at 22 in FIG. 1. Although the dry peel adhesive is shown disposed about the periphery of the label substrate, it should be recognized that it may be also disposed at various points throughout the labels either alternatively or in addition to the strip 22, for example, as shown at 23 in FIG. 1. However, in order to provide easy removal of the protective cover by the user, the layer of dry peel adhesive 22 is omitted from one corner such as the corner 30. As is noted a designation “peel here” with the arrow is printed on the upper surface of the label substrate thus instructing the user to merely lift that corner of the protective cover and remove it from the shielded label package 10 so that the die cut labels such as at 24 and 26 may then be removed for application to the desired application substrate by the consumer. It is of particular importance to the present invention that when the protective cover 20 is removed from the shielded label package, there is no remaining tacky adhesive residue on the label substrate or on the protective cover. That is the two are completely dry to the touch and neither the label substrate nor the protective cover will stick to other surfaces about the outer periphery thereof.

At the upper end or top of the shielded label package there is provided a die cut hole 32 which may be utilized to display the shielded label package 10 on a typical display board in a commercial retail establishment. Also as shown in FIG. 1, additional printing 34 is applied to the upper surface of the label substrate 16 by way of identification of the product. Standard bar codes and other identifying information which may be useful to the customer or helpful to the retailer in the sales of the product may also be included. As set forth above, this information may be placed anywhere on the product surface.

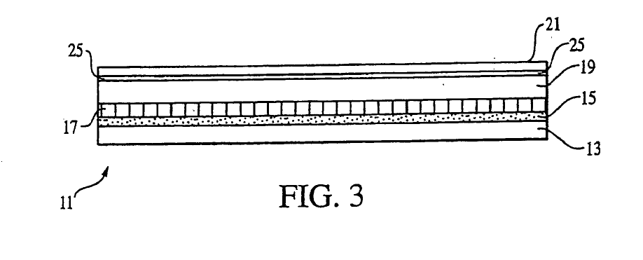

Referring now more particularly to FIG. 3, there is illustrated an alternative product which is constructed in accordance with the principles of the present invention and utilizing the method as set forth herein below. The shielded label product 11 as illustrated in FIG. 3 is constructed so as to provide a die cut label in the form of a card which may be blank or have indicia printed thereon which when removed from the carrier, does not contain an adhesive thereon but rather can be utilized for any purpose desired such as an identification card, a coupon, a card upon which the user may write desired indicia a security pass or any other type of card or label desired depending upon the particular application.

As is shown in FIG. 3, there is provided a carrier 13 upon which there is deposited a layer of pressure sensitive adhesive 15. A card stock 19 which functions as a label substrate has a release layer 17 applied to the lower surface thereof. A protective shield 21 is affixed to the upper surface of the label substrate by a dry peel adhesive 25 which may be of the type as above described. When the user desires to remove the die cut label in the form of the card or similar structure 19 the protective cover or shield 21 is removed as above described and the dry peel adhesive 25 is such that no tacky adhesive residue remains on either the protective cover 21 or the label substrate 19. Thereafter, the label substrate 19 may be removed from the carrier 13 leaving the layer of adhesive 15 affixed to the carrier 13 but with none of the adhesive secured to the bottom surface of the label substrate 19. Thus, the label substrate may be utilized as above described for any purpose desired by the carrier but in this instance, is not designed to be affixed to an application substrate as is the die cut label as illustrated in FIG. 2 and above described.

Referring now more particularly to FIG. 4, there is illustrated in schematic form an apparatus for manufacturing the shielded label package 10 as shown in FIGS. 1 and 2 and above described. As is therein illustrated, there is provided a roll 40 of stock from which the carrier 12 is formed. There is also provided a roll 42 of the label substrate material 16. Material from the roll 40 is passed by a coating station 44 for applying the release coating 14 to the upper surface 46 thereof. The label substrate material 42 is passed by a coating station 48 for application of the pressure-sensitive adhesive layer 18 to the lower surface 50 thereof. The two thusly coated strips of material are passed through a merging station 52 where the pressure-sensitive adhesive 18 is attached to the release layer 14. Thereafter, the combination of the two layers thusly secured together are passed through a printing station 54 where the characters such as those shown at 24 and 26 in FIG. 1 are printed onto the upper surface of the label substrate. The thusly printed label substrate is then passed through a die cut station 56 which die cuts each of the figures or labels as shown in FIG. 1 and as is illustrated schematically at 28 and above described. After the die cut of these figures the adhesive strip 22 is printed at the print adhesive strip station 58 around the periphery of the label substrate with the exception of the corner 30. The material is then passed through a second merger station 60 where the protective layer 20, which is provided from a roll 62 thereof is merged onto the top of the label substrate 16 and is adhered to the layer of adhesive 22 about the periphery thereof. The thus secured protective layer 20 is cured at the cure station 64 by passing the same adjacent a source of ultraviolet radiation which will cause the dry peel adhesive 22 to cure such that when the protective layer 20 is removed from the top of the shielded label package 10 there will be no sticky or tacky adhesive residue on the outer periphery of either the label substrate or the protective cover. Subsequent to the curing stage, the product is then passed through a finish trim stage 66 where excess material is trimmed and the hole 32 is cut into the entire combination of layers as shown in FIG. 2 so that the product may be appropriately hung from a peg on a display board or neck in a commercial establishment. After the finish trim, the material is passed through a sheeting stage 68 where the product is severed into individual shielded label packages as illustrated in FIG. 1 at 10 and is schematically graphically shown at 70 in FIG. 4. The thus completed shielded label package may be collected and placed into desired shipping cartons destined for the distributor or retailers as the case may be.

When a structure such as that illustrated in FIG. 3 and above described is to be manufactured, the coating station functions are reversed. That is, the release coat is applied to the label substrate at the station 48 and adhesive is applied to the carrier at the station 44. Otherwise, the remaining steps above-described are carried out to produce the product.

The shielded label package as above described has several distinct advantages over packages previously provided in the prior art. The first of these is that it is cost effective. When compared to the shrink-wrap package which is the package normally utilized for products such as those illustrated in FIG. 2 there is a 35% savings in the cost of manufacturing. Since the product is completely manufactured in-line as illustrated in FIG. 4 and above described, it is much faster to manufacture and thus consumes less time and effort than the handling that is required in other types of packaging for similar products. The resulting product as shown in FIGS. 1, 2 and 3 and above described is more pleasant to observe, it is clean, it is much easier to handle and the ease of entry, to obtain the die cut labels internally is much simpler as compared to the typical shrink-wrap product. In addition, since only the top layer is removed prior to utilization of the die cut labels there is less waste material to be discarded as compared to the shrink-wrap package. In addition to the foregoing, the method of manufacturing and the resulting product can be such that an infinite number of sizes and carrier materials can be utilized all depending upon the particular shielded label product desired by the consumer.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A non-resealable, shielded label package comprising:
a plurality of die cut labels formed in a label substrate adhesively secured to a carrier; and
a protective cover, adhesively secured disposed over said die cut labels and secured in place by an adhesive disposed about the periphery of said protective cover and said label substrate which when said protective cover is removed, leaves no tacky residue on said cover or said label substrate.

2. A non-resealable, shielded label package as defined in claim 1, wherein said adhesive securing said protective cover is a dry peel adhesive.

3. A non-resealable, shielded label package as defined in claim 2, wherein said dray peel adhesive is cured by exposure to ultraviolet radiation.

4. A non-resealable, shielded label package as defined in claim 3, wherein said dry peel adhesive is a cationic adhesive.

5. A non-resealable, shielded label package as defined in claim 2, wherein said dry peel adhesive is disposed about the periphery of said package and is not in contract with said die cut labels.

6. A non-resealable, shielded label package wherein said dry peel adhesive is disposed between said protective cover and said label substrate and is cured by exposure to ultraviolet radiation after said protective cover is secured.

7. A non-resealable, shielded label package as defined in claim 2, wherein said dry peel adhesive is disposed at various positions on said package excluding said die cut labels.

8. A non-resealable, shielded label package as defined in claim 7, wherein said dry peel adhesive is disposed between the protective cover and said die cut labels and is cured by exposure to ultraviolet radiation after said protective cover is secured.

9. A non-resealable, shielded label package comprising:
a carrier having front surface;
a release coating applied to the said front surface of said carrier;
a label substrate having first and second surfaces
a pressure sensitive adhesive layer on said first surface securing said label substrate to said front surface of said carrier;
a plurality of due cut labels in said label substrate;
dry peel adhesive disposed upon said second surface but not on said die cut labels; and
a light permeable protective cover secured to said dry peel adhesive, said dry peel adhesive being cured after said protective cover is secured so that when said protective cover is removed there is no tacky adhesive reside remaining on said label substrate or said protective layer.

10. A non-resealable, shielded label package as defined in claim 7 wherein said dry peel adhesive is cured by ultraviolet radiation.

11. A non-resealable, shielded label package as defined in claim 8 wherein said dry peel adhesive is a cationic adhesive.

12. A method of making a non-resealable, shielded label package comprising the steps of:
providing a label substrate to a surface of a carrier with a pressure sensitive adhesive;
printing a plurality of labels on said label substrate;
die cutting said plurality of labels;
applying dry peel adhesive upon said label substrate displaced form but not in contact with said labels;
securing a light permeable protective cover to said dry peel adhesive; and
curing said dry peel adhesive.

13. A method of making a non-resealable, shielded label package as defined in claim 12, wherein said curing step includes passing ultra violet radiation through said light permeable protective cover.

14. A method of making a non-resealable, shielded label package as defined in claim 12, which includes the further step of sheeting following the curing step.
